(19) United States
(12) Patent Application Publication
(10) Pub. No.: US 2023/0210139 A1
(43) Pub. Date: Jul. 6, 2023

(54) Carbonated Galactagogue Natural Energy Drink

(71) Applicants: Seth Cantler, El Paso, TX (US); Heather Cantler, El Paso, TX (US)

(72) Inventors: Seth Cantler, El Paso, TX (US); Heather Cantler, El Paso, TX (US)

(21) Appl. No.: 18/150,290

(22) Filed: Jan. 5, 2023

Related U.S. Application Data
(60) Provisional application No. 63/296,624, filed on Jan. 5, 2022.

(51) Int. Cl. A23L 2/02; A23L 2/68; A23L 2/60; A23L 2/56; A23C 11/10; A23L 2/52

(52) U.S. Cl. CPC A23L 2/02; A23L 2/68; A23L 2/60; A23L 2/56; A23C 11/103; A23L 2/52

(57) ABSTRACT

This present invention relates to a natural energy drink solution that enhances breastmilk production and letdown for an easier feeding experience. The drink solution is configured to replace standard energy drinks especially for breastfeeding women. More specifically, the drink solution contains all natural ingredients and includes dissolved carbon dioxide for creating the carbonated energy drink. The drink solution can be packaged in aluminum cans and can be available in a pack of two, four, six and more cans. The drink composition includes fenugreek, almonds, fennel, ginger, nettle, blessed thistle, dissolved CO2, and more. The drink solution is consumed by breastfeeding women before feeding or pumping and offers a safer and healthier alternative to regular highly caffeinated energy drinks.

### CROSS-REFERENCE TO RELATED APPLICATION

The present application claims priority to, and the benefit of, U.S. Provisional Application No. 63/296,624, which was filed on Jan. 5, 2022 and is incorporated herein by reference in its entirety.

### FIELD OF THE INVENTION

The present invention relates generally to carbonated drinks. More specifically, the present invention relates to a natural energy drink especially made for breastfeeding women. The energy drink is configured to provide energy and to enhance breastmilk production and flow. The energy drink contains natural ingredients and dissolved carbon dioxide for a fizzy and tangy taste and appearance. The energy drink offers a safer and healthier alternative to regular highly caffeinated energy drinks and enhances breastmilk production. Accordingly, the present disclosure makes specific reference thereto. Nonetheless, it is to be appreciated that aspects of the present invention are also equally applicable to other like applications, devices, and methods of manufacture.

### BACKGROUND

By way of background, an energy drink is a type of drink containing stimulant compounds, usually caffeine, which is marketed as providing mental and physical stimulation. Generally, the energy drinks are carbonated and may also contain sugar, other sweeteners, herbal extracts, taurine, and amino acids. A typical energy drink contains carbonated water, around 40 grams of sugar (from sucrose and/or glucose), 160 mg or more of caffeine, artificial sweetener, and herbs/substances associated with mental alertness and performance. Most of the energy drinks heretofore known lack scientific evidence with controlled trials to back up some of the benefits touted and advertised.

Many individuals drink several energy drinks in a day that can increase the consumption of caffeine beyond 400 mg and which can lead to anxiety, insomnia, heart problems (i.e., irregular heartbeat and elevated blood pressure), and in rare cases seizures or cardiac arrest. High sugar content of such drinks carries the same health risks associated with other sugar-sweetened beverages. Individuals desire an energy drink that does not have caffeine (or limited caffeine), but rather includes natural stimulating ingredients.

Caffeine and sugar in such drinks is detrimental, especially for pregnant and nursing women. It is recommended to limit caffeine intake for breastfeeding and pregnant women as small amounts pass into breastmilk and is consumed by babies and can build up over time. Excess intake may lead to infant sleeping issues and restlessness, anxiety, dizziness, as well as rapid heartbeat in women. Breastfeeding women drink caffeinated drinks to get over their fatigue and therefore, desire an improved energy drink that is safe to drink by pregnant and breastfeeding women. Often breastfeeding women include galactagogue in their diet to increase their breastmilk supply. Galactagogue may come in the form of a powder, a pill, or a liquid drink. Galactagogue, or galactogogue, also known as a lactation inducer or milk booster, is a substance that promotes lactation in humans and other animals. It may be synthetic, plant-derived, or endogenous. Galactagogues can be used to induce lactation and to treat low milk supply. The herbals cited as galactagogues include shatavari (Asparagus racemosus), fenugreek (Trigonella foenumgraecum), torbangun (Coleus amboinicus), which has been used by the Batak individuals of Indonesia as a galactogogue for hundreds of years. Foods considered to be galactagogues include whole grains, especially oatmeal; dark, leafy greens (alfalfa, kale, spinach, broccoli); fennel; garlic; chickpeas; nuts, and seeds, especially almonds; ginger; and papaya.

Generally, a woman takes or consumes galactagogue and an energy drink separately. Parents desire an energy drink that not only helps with fatigue but also enhances breastmilk production and supply.

Therefore, there exists a long-felt need in the art for a new energy drink that is safe to drink by breastfeeding women. There is also a long-felt need in the art for an energy drink that does not contain caffeine (or limited caffeine) nor high sugar content. Additionally, there is a long-felt need in the art for a carbonated drink that enhances breastmilk supply and provides energy upon consumption. Moreover, there is a long-felt need in the art for an energy drink that is a safer and healthier alternative to regular energy drinks. Further, there is a long-felt need in the art for an energy drink that is safe for both a lactating mother and breastfeeding child. Furthermore, there is a long-felt need in the art for an energy drink that contains natural ingredients. Finally, there is a long-felt need in the art for an improved energy drink which has a great taste, provides energy while also promoting improved breastmilk production for an easier feeding experience for the breastfeeding mother/baby.

The subject matter disclosed and claimed herein, in one embodiment thereof, comprises a galactagogue natural energy drink composition. The galactagogue energy drink composition contains natural ingredients that not only gives an energy boost during times of fatigue, but also enhances milk production and promotes milk letdown for an easier feeding experience. The composition further comprising ingredients including an extract of fenugreek plant, an extract of fennel, an extract of nettle, an extract of blessed thistle, almond powder, and ginger paste. The ingredients can be dissolved in distilled water, wherein the distilled water includes dissolved carbon dioxide for carbonating the drink and a sweetener flavoring agent for providing flavor to the energy drink composition.

In this manner, the carbonated galactagogue energy drink of the present invention accomplishes all of the foregoing objectives and provides breastfeeding and pregnant women an energy drink that not only helps in overcoming fatigue but also enhances breastmilk production and flow. The drink does not contain caffeine (or limited caffeine less than 100 mg) and includes natural ingredients and is therefore safe for breastfeeding women and children. The energy drink is a safer and healthier alternative to regular highly caffeinated energy drinks.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a galactagogue natural energy drink composition. The galactagogue energy drink composition contains natural ingredients that not only gives an energy boost during times of fatigue, but also enhances milk production and promotes milk letdown for an easier feeding experience. The composition further comprising ingredients including an extract of fenugreek plant, an extract of fennel, an extract of nettle, an extract of blessed thistle, almond powder, and ginger paste. The ingredients can be dissolved in distilled water, wherein the distilled water includes dissolved carbon dioxide for carbonating the drink and a sweetener flavoring agent for providing flavor to the energy drink composition.

In yet another embodiment, a natural carbonated energy drink for breastfeeding females is disclosed. The energy drink includes a water-based composition comprising at least 2 gm/100 ml of fenugreek extract, at least 3 gm/100 ml of almond powder, at least 1 gm/100 ml of fennel extract, at least 2 gm/100 ml of ginger, at least 2 gm/100 ml of nettle, at least 3 gm/100 ml of blessed thistle and at least 1 gm of CO2 dissolved in water. The composition, as described supra, does not include caffeine (or limited caffeine less than 100 mg).

In yet another embodiment, a 100 ml serving of the energy drink provides 25 g of carbohydrates, 1 g of protein, 10 g of fat, 20 g of sugar, 2 mg of calcium, 1 mg of sodium, and at least 1 mg of vitamin B12.

In yet another embodiment, the composition includes a water base.

In yet another embodiment, the composition includes a milk base.

In yet another embodiment, the energy drink is carbonated and partly meets the water intake requirements of breastfeeding women.

In yet another embodiment of the present invention, a carbonated breastmilk inducing energy drink container is disclosed. The container is made from recyclable aluminum and further comprising a cylindrical wall having an exterior surface, a logo disposed on the exterior surface, at least one nursing tip printed on the exterior surface, a cap covering the cylindrical wall, a pull tab for opening a tear strip positioned on the cap wherein the tear strip provides access to the stored energy drink.

In yet another embodiment, a method of boosting energy of a breastfeeding woman while also enhancing breastmilk production without imparting caffeine (or limiting caffeine) is described. The method includes the steps of providing a consumable composition, including within the composition, natural energy boosting and breastmilk production enhancing ingredients including at least 2 gm/100 ml of fenugreek extract, at least 3 gm/100 ml of almond powder, at least 1 gm/100 ml of fennel extract, at least 2 gm/100 ml of ginger, at least 2 gm/100 ml of nettle, at least 3 gm/100 ml of blessed thistle, at least 1 gm of dissolved CO2, and at least 6 gm/100 ml of one of sucrose or fructose in a vanilla, toasted vanilla, lemon, coconut, or chocolate flavor.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a block diagram showing one potential composition of a breastmilk promoting carbonated energy drink of the present invention in accordance with the disclosed architecture;

FIG. 2 illustrates a perspective view of an exemplary energy drink container storing the carbonated galactagogue energy drink of the present invention in accordance with the disclosed architecture; and

FIG. 3 illustrates a perspective view of a cardboard or plastic pack containing six energy drink containers of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an energy drink that is safe to drink by breastfeeding women. There is also a long-felt need in the art for an energy drink that does not have caffeine (or minimal caffeine) nor have a high sugar content. Additionally, there is a long-felt need in the art for a carbonated drink that enhances breastmilk supply and provides energy upon consumption. Moreover, there is a long-felt need in the art for an energy drink that is a safer and healthier alternative to regular energy drinks. Further, there is a long-felt need in the art for an energy drink that is safe for both a lactating woman and breastfeeding child. Furthermore, there is a long-felt need in the art for an energy drink that contains natural ingredients. Finally, there is a long-felt need in the art for an improved energy drink which has a great taste, provides energy while also promoting improved breastmilk production for an easier feeding experience for the breastfeeding woman/baby.

The present invention, in one exemplary embodiment, is a carbonated breastmilk inducing energy drink container. The container is in the form of a can and is made from recyclable aluminum and further comprising a cylindrical wall having an exterior surface, a logo disposed on the exterior surface, at least one nursing tip printed on the exterior surface, a cap covering the cylindrical wall, a pull tab for opening a tear strip positioned on the cap wherein the tear strip provides access to the stored energy drink.

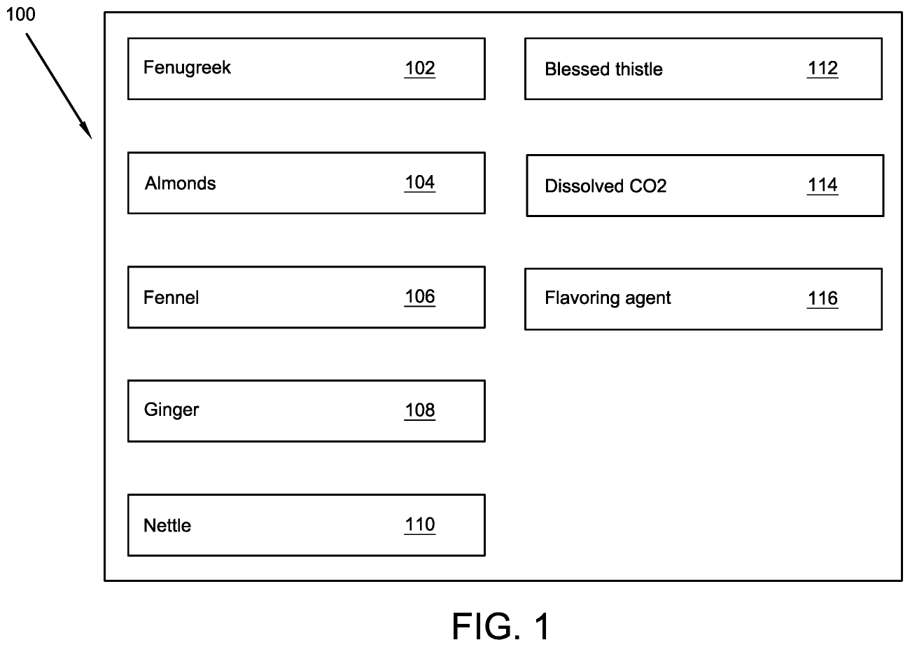

Referring initially to the drawings, FIG. 1 illustrates a block diagram showing one potential composition of the breastmilk promoting carbonated energy drink of the present invention in accordance with the disclosed architecture. The carbonated milk promoting energy drink 100 includes a composition formulated exclusively for breastfeeding women and includes a safer and healthier alternative to regular highly caffeinated energy drinks. The drink 100 not only provides an energy boost but also enhances breastmilk production and flow for an easier feeding experience. The drink 100 can be consumed at any time of the day and preferably at the beginning of the day before nursing or pumping the breastmilk. The compositions of the present invention provide an onset and maintenance of energy and mental alertness as well as nutrition and enhanced breastmilk production to the consumer. The term “beverage” or “drink” or “composition” as used herein denotes a composition that is a single-strength, ready to drink product that is consumable.

More specifically, the drink 100 includes a blend of natural ingredients including fenugreek 102, almonds 104, fennel 106, ginger 108, nettle 110, and blessed thistle 112. Fenugreek 102 is a plant that belongs to the pea family. Historically, fenugreek has been used to induce childbirth. Fenugreek is also commonly used to induce breastmilk production and is completely safe to consume while lactating.

Almonds 104 are packed with healthy fats, antioxidants, proteins, and calcium and therefore help in increasing the amount and sweetness of breastmilk while also providing energy to overcome fatigue. Fennel 106, an herb also known as Foeniculum vulgare is a part of the carrot family. Fennel 106 is an herbal galactagogue and has properties similar to the estrogen hormone that is naturally formed by the human body. Ginger 108 is a popular natural galactagogue specially to improve breastmilk volume in the immediate postpartum period without any notable side effect.

Nettle 110 is a natural galactagogue, an herb that supports breastmilk supply for nursing mothers. Nettle 110 supports lactation by providing essential nutrients. It is one of the most nutritious of the spring greens, containing high levels of vitamins and minerals, including iron, calcium, potassium, folic acid, B vitamins, vitamin K, and essential amino acids. Nettle 110 has some of the highest calcium levels when compared to other herbs, which allows for the nettle 110 to be a great tonic for the bones of breastfeeding women. Blessed thistle 112 is a galactagogue and enhances breastmilk supply. Blessed thistle 112 works best when combined with fenugreek and fennel seed. Blessed thistle 112 is especially useful when there is an increase in breast stimulation such as during pumping of milk.

The energy drink 100 further includes dissolved carbon dioxide (CO2) 114 for providing carbonation of the drink 100. The CO2 114 serves as a protective measure that keeps the energy drink fresh and prevents the growth of bacteria in the liquid while stored. Addition of CO2 also imparts sparkle and a tangy taste to the drink. The natural ingredients of the drink 100 eliminate belching or bloating that may be caused due to the accumulation of carbon dioxide gas.

It should be appreciated that the energy drink 100 is non-alcoholic and includes natural ingredients that promote breastmilk production and provides an energy boost. The drink keeps the nutritional value of the breastfeeding women at desired levels while providing vitamins and minerals. A natural sweetener flavoring agent 116 that includes one of sucrose, lactose, maltose, and fructose sugar can be used in the drink 100. The flavoring agent enhances palatability of the drink. The natural flavoring agent can be used in the present invention. Optionally, caffeine can be used in limited quantities (i.e. less than 100 mg per serving). Water (i.e., agua) and milk can be used as a natural solvent for preparing the energy drink. The milk can include nondairy milk varieties of plant-based options consisting of a nut, an oat, a rice, and a coconut.

An additional protein source may optionally be added in the composition and can be selected from a variety of materials, including without limitation to, milk protein, whey protein, caseinate, soy protein, egg whites, gelatins, collagen, and combinations thereof. The natural energy drink solution in the present invention, due to the presence of the aforementioned natural sweetener flavoring agent 116, is sweetened enough to at least dilute or subdue the strong flavors of the other components and ingredients. The energy drink can also comprise flavoring agents selected from the group consisting of a mango flavor, an apple flavor, a pineapple flavor, a guava flavor, a cocoa flavor, a papaya flavor, a peach flavor, an apricot flavor, a vanilla flavor, a lemon flavor, a coconut flavor, a toasted vanilla, and more. The solution composition can be made according to methods which will be well known by the ordinary skilled artisan.

Table 1 below shows approximate concentrations of various ingredients in the composition of the energy drink.

TABLE 1

| | Composition in percentage by weight |
|---|---|
| Ingredients | (% w/v) (gm/100 ml) |
| Fenugreek | 1-3 |
| Almonds | 3-5 |
| Fennel | 0.5-2.5 |
| Ginger | 1.5-3.5 |
| Nettle | 1-3 |
| Blessed thistle | 2-4 |
| Dissolved CO2 | 0.5-2.5 |
| Natural sweetener flavoring agent | 4-8 |

Table 2 shows approximate supplemental facts provided by the composition of the energy drink in 100 ml of drink.

TABLE 2

| Nutrients | Per 100 ml |
|---|---|
| Carbohydrates (g) | 20-30 |
| Protein (g) | 0.5-2.0 |
| Fat (g) | 5-15 |
| Sugar (g) | 15-25 |
| Calcium (mg) | 1-3 |
| Sodium (mg) | 0.5-2 |
| Vitamin B12 (mg) | 0.5-2.5 |
| Calories | 60-160 |

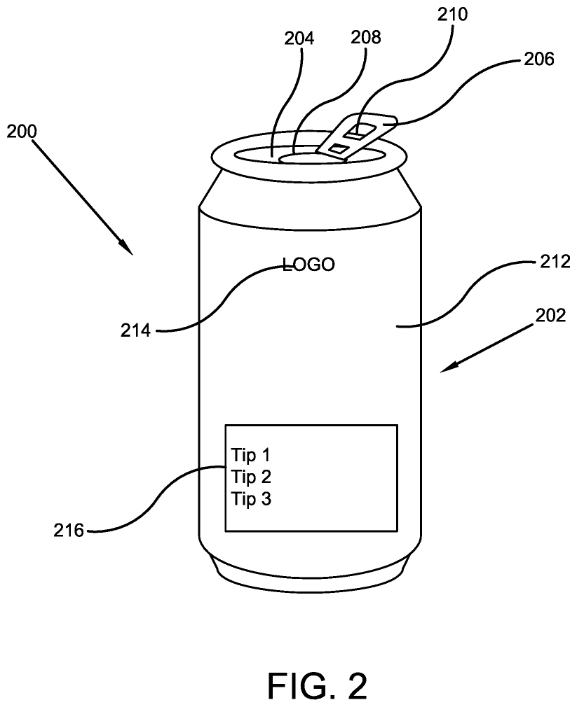

FIG. 2 illustrates a perspective view of an exemplary energy drink container 200 storing the carbonated galactagogue energy drink of the present invention in accordance with the disclosed architecture. As illustrated, the beverage container 200 is in the form of a can that stores the carbonated energy drink 100. The container 200 includes a cylindrical wall 202 having a cap 204. The cap 204 further includes a pull tab 206 that is configured to be pulled for tearing a tear strip 208 for accessing the stored energy drink 100. The pull tab 206 includes a ring 210 that can be used for pulling the pull tab 206 using a finger.

The exterior surface 212 of the cylindrical wall 202 may have a logo or any other indicia 214 disposed thereon. The logo can be a trademark, copyright, or any other indicia. Further, the exterior surface 212 may have breastfeeding (i.e., nursing) tips 216 printed thereon. The nursing tips 216 are used for providing guidance to the consumers who purchase the container 200.

The container 200 may be designed to indicate a flavor of the carbonated drink 100. Further, the container 200 may come in a variety of sizes having capacity of 10 oz., 12 oz., 15 oz., 20 oz. or having any other storage capacity. The container 200 is preferably made from aluminum and is portable, lightweight, and recyclable. The aluminum material allows the can 200 to be chilled easily and provides a barrier for the drink 100 against air, light, and moisture. It should be noted that the container 200 can alternatively be in the form of a bottle, a tumbler, or a mason jar.

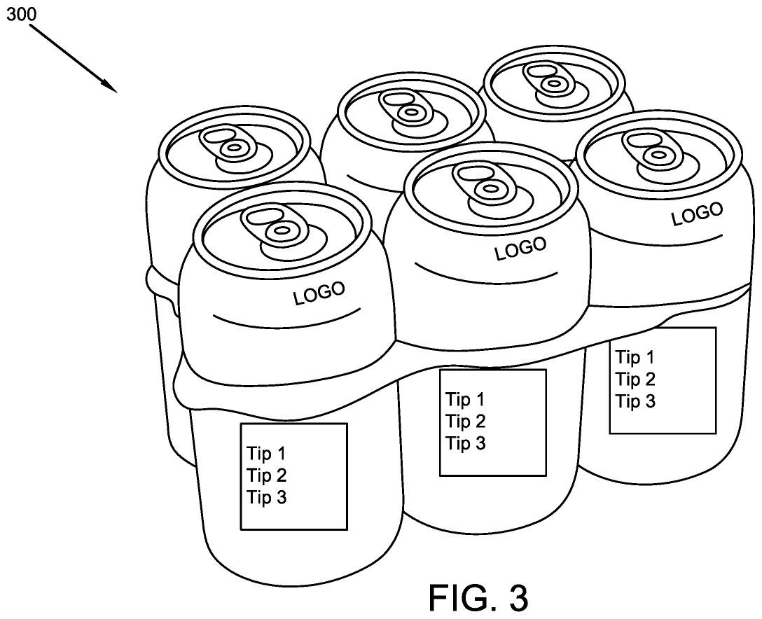

FIG. 3 illustrates a perspective view of a cardboard or plastic pack containing six energy drink containers of the present invention in accordance with the disclosed architecture. The energy drink containers of the present invention can be commercially available in the form of a single container, a pack of two, four, six, twelve or more. Here, in the present embodiment, a cardboard or plastic pack 300 contains six beverage cans of the present invention. It should be noted that the individual cans can be of the same flavor or different flavor and further can be of the same or different sizes.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “breastmilk promoting carbonated energy drink”, “carbonated energy drink”, “drink”, and “galactagogue energy drink composition” are interchangeable and refer to the breastmilk enhancing natural carbonated energy drink 100 of the present invention. Similarly, as used herein “container”, “energy drink container’, “beverage container”, and “can” are interchangeable and refer to the breastmilk enhancing natural carbonated energy drink container 200 of the present invention.

Notwithstanding the foregoing, the breastmilk enhancing natural carbonated energy drink container 200 of the present invention can be of any suitable size and configuration as is known in the art without affecting the overall concept of the invention, provided that it accomplishes the above-stated objectives. One of ordinary skill in the art will appreciate that the breastmilk enhancing natural carbonated energy drink container 200 as shown in the FIGS. are for illustrative purposes only, and that many other sizes and shapes of the breastmilk enhancing natural carbonated energy drink container 200 are well within the scope of the present disclosure. Although the dimensions of the breastmilk enhancing natural carbonated energy drink container 200 are important design parameters for user convenience, the breastmilk enhancing natural carbonated energy drink container 200 may be of any size that ensures optimal performance during use and/or that suits the user's needs and/or preferences.

Notwithstanding the foregoing, the breastmilk enhancing natural carbonated energy drink 100 of the present invention can have any suitable natural ingredient as is known in the art without affecting the overall concept of the invention, provided that it accomplishes the above-stated objectives. One of ordinary skill in the art will appreciate that the composition of the breastmilk enhancing natural carbonated energy drink 100 as shown in the FIGS. are for illustrative purposes only, and that many compositions are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A drink solution for enhancing breastmilk production, the drink solution comprising:
a drinkable solution comprised of a fenugreek, an almond, a fennel, a ginger, a nettle and a blessed thistle;
a dissolved carbon dioxide; and
a sweetener agent selected from a group consisting of a sucrose, a lactose, a maltose and a fructose sugar.

2. The drink solution of claim 1 further comprising a solvent selected from a group consisting of a water and a milk.

3. The drink solution of claim 2 further comprising a protein source selected from a group consisting of a milk protein, a whey protein, a caseinate, a soy protein, an egg white, a gelatin and a collagen.

4. The drink solution of claim 2, wherein said fenugreek is from 1-3 grams per 100 ml, said almond is from 3-5 grams per 100 ml, said fennel is from 0.5-2.5 grams per 100 ml, said ginger is from 1.5-3.5 grams per 100 ml, said nettle is from 1-3 grams per 100 ml, and said blessed thistle is from 2-4 grams per 100 ml.

5. The drink solution of claim 4, wherein said dissolved carbon dioxide is from 0.5-2.5 grams per 100 ml.

6. The drink solution of claim 5 further comprising a flavoring agent selected from a group consisting of a mango flavor, an apple flavor, a pineapple flavor, a guava flavor, a cocoa flavor, a papaya flavor, a peach flavor, an apricot flavor, a vanilla flavor, a lemon flavor, a coconut flavor, and a toasted vanilla flavor.

7. The drink solution of claim 6, wherein said flavoring agent is from about 4-8 grams per 100 ml.

8. A drink solution for enhancing a breastmilk production, the drink solution comprising:
a drinkable solution comprised of a fenugreek, an almond, a fennel, a ginger, a nettle and a blessed thistle;
a dissolved carbon dioxide; and
a flavoring agent selected from a group consisting of a mango flavor, an apple flavor, a pineapple flavor, a guava flavor, a cocoa flavor, a papaya flavor, a peach flavor, an apricot flavor, a vanilla flavor, a lemon flavor, a coconut flavor, and a toasted vanilla flavor.

9. The drink solution of claim 8 further comprising a solvent selected from a group consisting of a water and a milk.

10. The drink solution of claim 9 further comprising a protein source selected from a group consisting of a milk protein, a whey protein, a caseinate, a soy protein, an egg white, a gelatin and a collagen.

11. The drink solution of claim 9, wherein said fenugreek is from 1-3 grams per 100 ml, said almond is from 3-5 grams per 100 ml, said fennel is from 0.5-2.5 grams per 100 ml, said ginger is from 1.5-3.5 grams per 100 ml, said nettle is from 1-3 grams per 100 ml, and said blessed thistle is from 2-4 grams per 100 ml.

12. The drink solution of claim 9, wherein said dissolved carbon dioxide is from 0.5-2.5 grams per 100 ml.

13. The drink solution of claim 9, wherein said flavoring agent is from about 4-8 grams per 100 ml.

14. The drink solution of claim 9 further comprising a sweetener agent selected from the group consisting of a sucrose, a lactose, a maltose and a fructose sugar.

15. A method of enhancing breastmilk production comprising the steps of:
providing a drinkable solution comprised of a fenugreek, an almond, a fennel, a ginger, a nettle, a blessed thistle, a dissolved carbon dioxide, and a flavoring agent selected from a group consisting of a mango flavor, an apple flavor, a pineapple flavor, a guava flavor, a cocoa flavor, a papaya flavor, a peach flavor, an apricot flavor, a vanilla flavor, a lemon flavor, a coconut flavor, and a toasted vanilla flavor; and
consuming the drinkable solution.

16. The method of enhancing breastmilk production of claim 15, wherein said drinkable solution further comprises a solvent selected from a group consisting of a water and a milk.

17. The method of enhancing breastmilk production of claim 15, wherein said drinkable solution further comprises a protein source selected from a group consisting of a milk protein, a whey protein, a caseinate, a soy protein, an egg white, a gelatin and a collagen.

18. The method of enhancing breastmilk production of claim 15, wherein said fenugreek is from 1-3 grams per 100 ml, said almond is from 3-5 grams per 100 ml, said fennel is from 0.5-2.5 grams per 100 ml, said ginger is from 1.5-3.5 grams per 100 ml, said nettle is from 1-3 grams per 100 ml, and said blessed thistle is from 2-4 grams per 100 ml.

19. The method of enhancing breastmilk production of claim 15, wherein said drinkable solution further comprises a caffeine.

20. The method of enhancing breastmilk production of claim 16, wherein said milk is a plant-based milk selected from a group consisting of a nut, an oat, a rice, and a coconut.
